(19) United States
(12) Patent Application Publication
(10) Pub. No.: US 2015/0364785 A1
(43) Pub. Date: Dec. 17, 2015

(54) APPARATUS FOR ASSEMBLING FUEL CELL STACK

(71) Applicants: Hyundai Motor Company, Seoul (KR); Kia Motors Corporation, Seoul (KR)

(72) Inventors: Nam Gu LEE, Yongin-si (KR); Sang Hyun CHO, Hwaseong-si (KR)

(21) Appl. No.: 14/528,875

(22) Filed: Oct. 30, 2014

(30) Foreign Application Priority Data
Jun. 17, 2014 (KR) 10-2014-0073238

(51) Int. Cl. H01M 8/24

(52) U.S. Cl. CPC H01M 8/247

(57) ABSTRACT

An apparatus for assembling a fuel cell stack includes a cartridge provided on a horizontal surface at an inclined angle and serving to support a plurality of sheets of stack-assembly materials so that a bottom surface and a lateral surface of the stack-assembly material are supported by inner surfaces thereof. An angle-adjustment unit variably adjusts the inclined angle of the cartridge in response to a degree of stacking of the stack-assembly materials.

### CROSS-REFERENCE TO RELATED APPLICATION

The present application claims the benefit of priority to Korean Patent Application Number 10-2014-0073238 filed on Jun. 17, 2014, the entire contents of which application are incorporated herein for all purposes by this reference.

### TECHNICAL FIELD

The present disclosure relates, in general, to an apparatus for assembling a fuel cell stack, and more particularly, to an apparatus for assembling a fuel cell stack, which minimizes a stacking error occurring during stacking of materials, thereby reducing defects of the fuel cell stack and improving performance of a fuel cell.

### BACKGROUND

Generally, a fuel cell stack for a vehicle has a structure in which a plurality of cells are connected in serial and generate electricity by a chemical reaction between hydrogen and oxygen to drive a motor with the generated electricity.

A unit cell of the fuel cell stack includes an anode separation plate and a cathode separation plate which are separately provided on both sides of a membrane electrode assembly (MEA), on both sides of which gas-diffusion layers are respectively attached. The fuel cell stack is formed by repeatedly stacking the respective unit cells on one another.

In stacking the fuel cell stacks, the anode separation plate, the MEA, and the cathode separation plate are stacked on a vertical cartridge with a mounting tolerance of several millimeters.

According to the related art, a device for assembling a fuel cell stack is disclosed. In the device, material layers are sequentially stacked on a vertical cartridge based on a guide on an external side of a separation plate with an arrangement tolerance of approximately less than 5 mm.

However, due to a guide error and a deviation in the arrangement of the material layers, the arrangement tolerance may be increased. Further, since the material layers, which are stacked between a front part and a rear part, are unfastened, an assembly error may error. This affects the performance of a fuel cell stack and causes even a breakdown of the fuel cell stack.

The foregoing is intended merely to aid in the understanding of the background of the present invention, and is not intended to mean that the present invention falls within the purview of the related art that is already known to those skilled in the art.

### SUMMARY

The present disclosure has been made keeping in mind the above problems occurring in the related art. The present disclosure is intended to propose an apparatus for assembling a fuel cell stack, which minimizes a stacking error occurring during stacking of materials, thereby reducing defects of the fuel cell stack and improving performance of a fuel cell.

According to one aspect of the present inventive concept, an apparatus for assembling a fuel cell stack includes a cartridge provided on a horizontal surface at an inclined angle and supporting a plurality of sheets of stack-assembly materials so that a bottom surface and a lateral surface of the stack-assembly materials are supported by inner surfaces thereof. An angle-adjustment unit variably adjusts the inclined angle of the cartridge in response to a degree of stacking of the stack-assembly materials.

The angle-adjustment unit may adjust the inclined angle of the cartridge so that a first side of the cartridge tilts up and down about a second side of the cartridge.

The angle-adjustment unit may include a weight sensor provided on the second side of the cartridge to measure a weight of the materials being stacked. A level-adjustment section rotatably connected to the first side of the cartridge and adjusts a level of the first side of the cartridge in response to its own movement action. A controller is configured to receive the weight measured by the weight sensor and send a motion signal corresponding to the received weight to the level-adjustment section to variably adjust the inclined angle of the cartridge with respect to the horizontal surface.

The level-adjustment section may include a rod rotatably connected to the first side of the cartridge at one side thereof. A moving plate, to which the other side of the rod is connected, linearly moves along the horizontal surface in the radial direction from the second side of the cartridge.

The moving plate may be provided with rollers at a lower portion thereof, wherein the rollers roll along rails provided below the moving plate.

The controller may correlate the inclined angle with respect to the weight of the materials such that the inclined angle is inversely proportional to the weight of the materials.

The inclined angle with respect to the weight of the materials may be controlled to be within a reference angle range.

The cartridge may have a total allowable weight of materials being stacked, such that the specific angle range varies in response to a magnitude of weight within the total allowable weight so that the inclined angle is controllably adjusted.

The reference angle range may range from 30 degrees to 60 degrees.

According to the present disclosure, the materials are stacked on the cartridge while an inclined angle gradually varies by means of the level-adjustment section, thereby maintaining a contact state of the stacked materials with respect to a support plate and a guide plate of the cartridge. Further, a stacking error of a later-assembled material to previously-assembled materials is reduced, and the stacking quality, stacking reliance, and constant quality of a product are increased.

### BRIEF DESCRIPTION OF THE DRAWINGS

The above and other objects, features and advantages of the present invention will be more clearly understood from the following detailed description when taken in conjunction with the accompanying drawings.

FIG. 1 is a view showing the construction of an apparatus for assembling a fuel cell stack according to an embodiment of the present inventive concept.

FIG. 2A is a view showing a case where a stacking error exists according the related art.

FIG. 2B is a view showing a case where a stacking error does not according to an embodiment of the present inventive concept.

FIG. 3A is a view showing an inclined angle of a cartridge according to the related art.

FIG. 3B is a view showing an inclined angle of a cartridge of the apparatus according to the embodiment of the present inventive concept.

### DETAILED DESCRIPTION

Hereinbelow, exemplary embodiments of the present inventive concept will be described in detail with reference to the accompanying drawings.

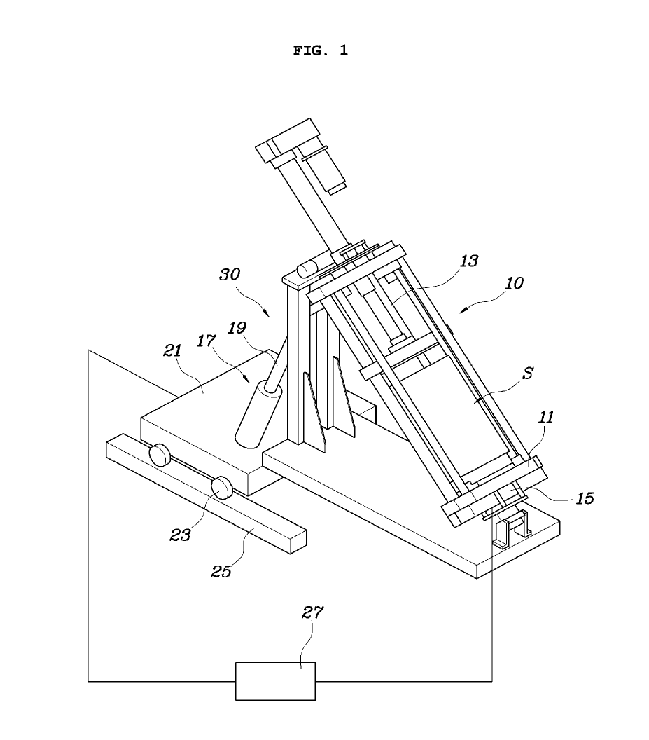

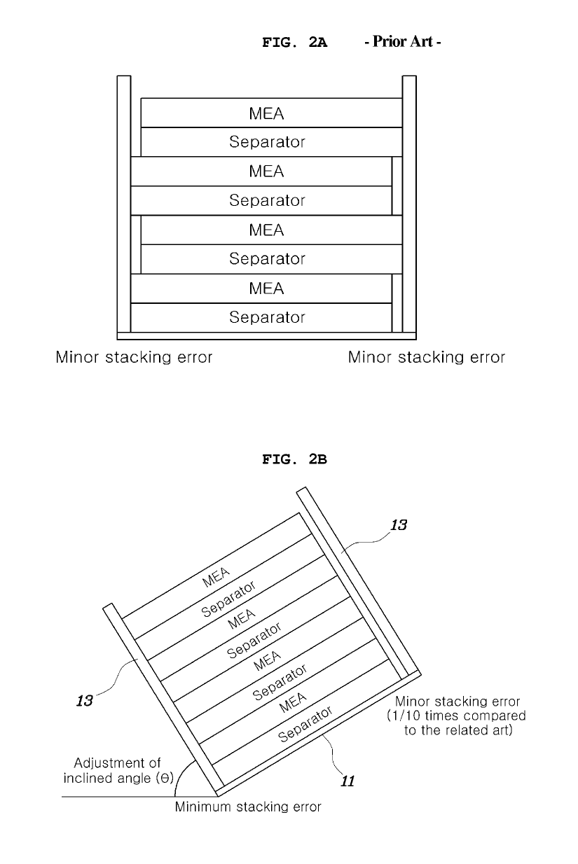

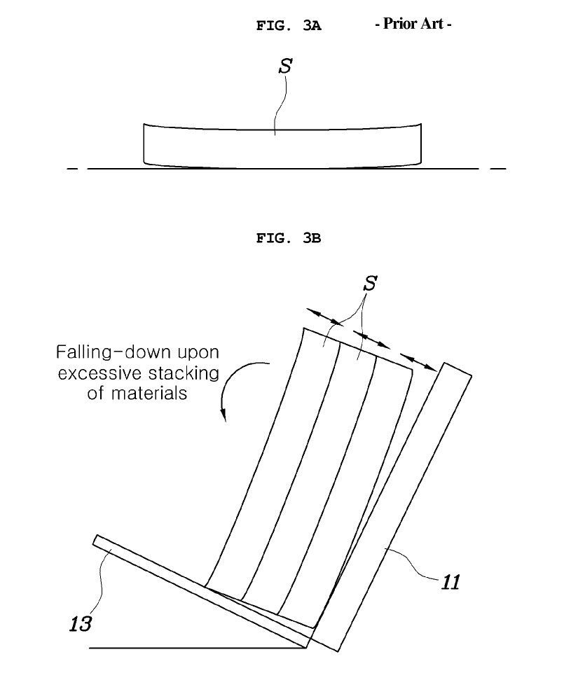

FIG. 1 is a view showing the construction of an apparatus for assembling a fuel cell stack according to an embodiment of the present inventive concept. FIGS. 2A and 2B are views showing two cases where a stacking error exists or not according to whether to use the apparatus for assembling a fuel cell stack of an embodiment of the present inventive concept. FIGS. 3A and 3B are views showing the reason why an inclined angle of a cartridge of the apparatus should be adjusted.

Referring to FIG. 1, the apparatus for assembling a fuel cell stack includes a cartridge 10 which is provided on a horizontal surface at an inclined angle and serves to support a plurality of sheets of stack-assembly materials so that bottom surfaces and lateral surfaces of the stack-assembly materials are supported by inner surfaces thereof. An angle-adjustment unit 30 serves to variably adjust an inclined angle of the cartridge 10 in response to the degree of stacking of the stack-assembly materials.

Here, the materials may include an anode separator, an MEA, a cathode separator, and the like. The cartridge 10 may include a support plate 11 and a plurality of guides 13, which are provided for stacking the materials.

Specifically, the support plate 11 is provided at a lower end of the cartridge 10 so as to support the bottom surfaces of the materials, and the guides 13 are provided at front and rear sides of the cartridge 10. The guide 13 at the rear side of the cartridge 10 may support lateral sides of the materials to be stacked, and an end plate may be stacked on the support plate 11 before stacking the materials.

That is, the materials are sequentially stacked in the cartridge 10 while the cartridge is tilted at a reference inclined angle, so that bottom surfaces of the materials (which face the support plate 11) and one side of the materials (which face a guide 13 at the rear side of the cartridge) are simultaneously supported by the inner surfaces of the cartridge 10. Particularly, when the materials are stacked, the cartridge 10 is gradually tilted by the angle-adjustment unit 30, thereby allowing the materials to come into contact with the support plate 11 and the guide 13, and thus reducing an assembly error of the materials with respect to previously stacked materials.

As shown in FIG. 2B, when the materials are stacked with the guides 13 installed to the cartridge 10, the materials are stacked and leaned toward one guide 13, and thus, a stacking error can be reduced 1/10 times compared to an existing stacking method as shown in FIG. 2A.

Thus, the stacking quality of the materials increases, and thereby obtaining excellent stacking reliability and constant quality of a product.

The angle-adjustment unit 30 may enable a first side of the cartridge 10 to tilt up and down about a second side, thereby variably adjusting the inclined angle of the cartridge 10.

In an exemplary embodiment, the angle-adjustment unit 30 may include a weight sensor 15 which is provided on the second side of the cartridge 10 so as to measure the weight of the material being stacked. A level-adjustment section is rotatably connected to the first side of the cartridge and is configured to adjust a level of the first side of the cartridge 10 in response to its own movement action. A controller 27 is configured to receive the weight measured by the weight sensor 15 and send a motion signal corresponding to the received weight to the level-adjustment section 17 to variably adjust the inclined angle of the cartridge 10 with respect to a horizontal surface.

That is, the weight sensor 15 for measuring the weight of the materials is mounted to a lower side of the support plate 11, so that the weight sensor 15 can measure the weight of the materials to be stacked thereon. In addition, the level-adjustment section 17 may be installed on an upper side of the cartridge 10, so that the level-adjustment section 17 can tilt the upper side of the cartridge 10 up and down about the lower side of the cartridge 10 in response to the measured weight of the materials.

Thus, the inclined angle of the guide 13 of the cartridge 10 with respect to the horizontal surface is regulated with the operation of the level-adjustment section, thereby variably adjusting the inclined angle of the cartridge 10.

The level-adjustment section 17 may include a rod 19 which is rotatably connected to the upper or first side of the cartridge 10 at one side thereof. A moving plate 21 to which the other side of the rod 19 is connected to linearly move along the horizontal surface in a radial direction from the second side of the cartridge 10.

Here, the moving plate 21 may be provided with rollers at a lower portion thereof, and the rollers 23 roll along rails 25 provided below the moving plate 21.

As the weight of the materials increases, the controller 27 sends the motion signal corresponding to the increased weight to the moving plate 21 or rollers 23 to allow the moving plate 21 to move rearwards. Then, a top dead center of the rod 19 mechanically moves down so that the inclined angle decreases.

Conversely, as weight of the materials decreases, the controller 27 sends the motion signal corresponding to the decreased weight to the moving plate 21 or rollers 23 to allow the moving plate 21 to move forwards. Then, the top dead center of the rod 19 mechanically moves up so that the inclined angle increases.

Here, the moving plate 21 or the rollers 23 may be provided with an operating unit (not shown), such as an actuator, which serves to provide an actuating force in response to the motion signal from the controller.

Like this, the controller 27 may correlate the inclined angle with respect to the weight of the materials such that the inclined angle is controlled to be inversely proportional to the weight of the materials. The inclined angle with respect to the weight of the materials may be controlled to be within a reference angle range from 30 degrees to 60 degrees.

The cartridge 10 may be configured to have a total allowable weight of materials being stacked, such that the specific angle range varies in response to the magnitude of weight within the total allowable weight so that the inclined angle is controllably adjusted.

An example of variably adjusting the including angle of the cartridge 10 for stacking materials will be described hereinafter.

As shown in FIG. 3A, a single separator generally has a thickness of about 1.7 mm and is generally made of a metal material. A machined metal separator has residual stress due to a spring back phenomenon, so that it has its own deformation tolerance of about 1.5 mm. Because of this, if either only a lower side or a lateral side of the separator is supported, the unsupported side of the separator may have degree of freedom in an arrangement of materials, thus affecting the assembly of the materials.

Thus, according to the present disclosure, the separators (materials) are stacked as the cartridge 10 tilts at a reference inclined angle and supports the bottom surfaces and lateral sides of the separators, thereby preventing a stacking error.

However, when the materials are continuously stacked at a fixed inclined angle, the center of gravity of the materials varies as the weight of materials changes.

That is, if the materials are stacked and only lateral sides of the materials are supported, as shown in FIG. 3B, the separators gradually come off the support plate in the stacking direction, thus creating a cumulative stacking tolerance corresponding to tens of millimeters and resulting in falling towards the guide 13.

Thus, according to the present disclosure, as the weight of the materials varies, the inclined angle of the cartridge can be variably adjusted depending upon the weight of the materials using a correlation between the inclined angle and the varied weight.

Here, the correlation can be obtained, taking account of the reference angle range and the total allowable weight of the materials, and can be expressed as follows:

θ=(m²)−(bm)+c

(where θ is a positive number, m is the weight of materials, and b and c are constants)

As an example, when materials are sequentially stacked at θ=60 degrees, the materials are in close contact with the guide 13. Then, when the materials are continuously stacked in the cartridge so that θ=30 degrees, supply of materials is completed.

Here, θ is controlled with the weight of the materials being stacked, and the total allowable weight (40 kg) of the materials to be stacked in the cartridge 10 is uniformly distributed within 30 degrees to 60 degrees of the inclined angle (θ). After the materials are supplied, the guide 13 on which the materials are closely stacked is fixed so that the stacked materials are fixedly arranged, followed by pressing the stacked materials at a reference angle.

The reference angle ranges from 30 degrees to 60 degrees because if the inclined angle θ of the cartridge 10 is zero degree, although friction force applied between the guide 13 and the lateral side of the materials has the highest value, the friction force between a bottom side of the materials and the support plate 11 decreases so that all of the materials may fall down.

If the inclined angle θ is 90 degrees, although the friction force between the bottom side of the materials and the support plate 11 has a maximum value, the friction force between the lateral sides of the materials and the guide 13 decreases so that a stacking error may occur. Thereby, in order to realize the proper stacking along with a minimum support of the materials, the reference angle ranges from minimum 30 degrees to maximum 60 degrees.

Although the exemplary embodiment of the present inventive concept has been described for illustrative purposes, those skilled in the art will appreciate that various modifications, additions and substitutions are possible, without departing from the scope and spirit of the invention as disclosed in the accompanying claims.

What is claimed is:

1. An apparatus for assembling a fuel cell stack, the apparatus comprising:
a cartridge provided on a horizontal surface at an inclined angle and supporting a plurality of sheets of stack-assembly materials so that a bottom surface and a lateral surface of the stack-assembly materials are supported by inner surfaces thereof; and
an angle-adjustment unit variably adjusting the inclined angle of the cartridge in response to a degree of stacking of the stack-assembly materials.

2. The apparatus according to claim 1, wherein the angle-adjustment unit adjusts the inclined angle of the cartridge so that a first side of the cartridge tilts up and down about a second side of the cartridge.

3. The apparatus according to claim 2, wherein the angle-adjustment unit comprises:
a weight sensor provided on the second side of the cartridge to measure a weight of the stack-assembly materials being stacked;
a level-adjustment section rotatably connected to the first side of the cartridge and adjusting a level of the first side of the cartridge in response to its own movement action; and
a controller configured to receive the weight, measured by the weight sensor, and to send a motion signal corresponding to the received weight to the level-adjustment section to variably adjust the inclined angle of the cartridge with respect to the horizontal surface.

4. The apparatus according to claim 3, wherein the level-adjustment section comprises:
a rod rotatably connected to the first side of the cartridge at one side thereof; and
a moving plate to which the other side of the rod is connected and which linearly moves along the horizontal surface in a radial direction from the second side of the cartridge.

5. The apparatus according to claim 4, wherein the moving plate is provided with rollers at a lower portion thereof, wherein the rollers roll along rails provided below the moving plate.

6. The apparatus according to claim 3, wherein the controller correlates the inclined angle with respect to the weight of the materials such that the inclined angle is controlled to be inversely proportional to the weight of the materials.

7. The apparatus according to claim 6, wherein the inclined angle with respect to the weight of the materials is controlled to be within a reference angle range.

8. The apparatus according to claim 7, wherein the cartridge has a total allowable weight of the materials being stacked, such that the specific angle range varies in response to the magnitude of weight within the total allowable weight so that the inclined angle is controllably adjusted.

9. The apparatus according to claim 7, wherein the reference angle range ranges from 30 degrees to 60 degrees.

10. The apparatus according to claim 1, wherein the cartridge comprises:
a support plate provided at a lower end of the cartridge to support the bottom surface of the stack-assembly materials;
a plurality of guides provided at the rear side of the cartridge to support the lateral surface of the stack-assembly materials; and
an end plate stacked on the support plate before stacking the materials.
